(19) United States
(12) Patent Application Publication
(10) Pub. No.: US 2015/0227935 A1
(43) Pub. Date: Aug. 13, 2015

(54) PAYMENT AUTHORIZATION DATA PROCESSING SYSTEM FOR OPTIMIZING PROFITS OTHERWISE LOST IN FALSE POSITIVES

(71) Applicant: Brighterion, Inc., San Francisco, CA (US)

(72) Inventor: Akli Adjaoute, Mill Valley, CA (US)

(73) Assignee: Brighterion, Inc., San Francisco, CA (US)

(21) Appl. No.: 14/690,380

(22) Filed: Apr. 18, 2015

Related U.S. Application Data
(63) Continuation of application No. 14/634,786, filed on Feb. 28, 2015.
Application No. 14/634,786 is a continuation-in-part of application No. 14/675,453, filed on Mar. 31, 2015.

(51) Int. Cl. G06Q 20/40; G06N 99/00; G06N 5/04

(52) U.S. Cl. CPC G06Q 20/4016; G06Q 20/409; G06N 5/04; G06N 99/005

(57) ABSTRACT

A financial payment authorization data processing system comprises a payment transaction request fraud scoring data structure that suffers occasionally from falsely scoring a legitimate transaction by a cardholder as fraudulent and would otherwise “decline” the transaction request. A so-called “false positive”. The financial payment authorization data processing system further includes a smart agent data structure to individually follow past transaction data and behaviors, and to provide its artificial intelligence observations on the magnitude, type, and quality of payment card revenues and business routinely engaged in by the cardholder who's transaction request is on the table. The computed level of transaction risk that is acceptable is raised in proportion to the cardholder's business value. As a further expedient, such quality cardholders would never be subject to a “declined transaction” if the requested payment transaction was less than some liberal minimum.

### BACKGROUND OF THE INVENTION

1. Field of the Invention

The present invention relates to financial payment authorization data processing systems on networks, and more particularly to using artificial intelligence decision platforms to favor certain payment authorization requests with approvals because of the disproportionate impacts to future profits suffered for false positives relating to eligible “high-roller” cardholders.

2. Background

Some payment cardholders generate far more income for card issuers than do the average cardholder. So fraud scoring mechanisms that treat them all the same are wasting substantial business and profits. By one account, eleven percent of accountholders that suffered a false positive “transaction declined” experience did not use the same payment card again for three months. A competitor got the business. Card issuers using fraud scoring alone lose far more business than their of the risk of approving a seemingly dicey transaction.

When a financial payment authorization data processing system declines a fraudulent transaction, it's done its job and profits are not lost to fraud. Similarly, when a legitimate transaction is approved, it's again done its job and profits are made this time on the genuine business. But, whenever the financial payment authorization data processing system delivers a false negative, a fraudulent transaction gets authorized. It's accepted as a cost of doing business, and these keep the fraudsters coming back for another bite.

Whenever a financial payment authorization data processing system delivers a false positive, a legitimate transaction gets declined. That mistake, however, can cost big because it discourages and disappoints legitimate cardholders who may stay away for months and never come back. (They have too many alternative payment cards available to them.) For example, stopping $5 billion in fraud makes no sense if the fraud scoring mechanism drove away $80 billion in profits. And that seems to be the case with conventional financial payment authorization data processing systems.

The consequential behavioral impacts on customers and clients should be factored into credit authorization decisions, as well as the quality of the business being obstructed. The old saying applies here, “Penny wise and pound foolish.” But with this card issuers are being prudent and thrifty focusing on fraud, transaction-by-transaction, but being wasteful and profligate with revenues and profits on the whole.

### SUMMARY OF THE INVENTION

Briefly, a financial payment authorization data processing system embodiment of the present invention comprises a payment transaction request fraud scoring data structure that suffers occasionally from falsely scoring a legitimate transaction by a cardholder as fraudulent and would otherwise “decline” the transaction request. A so-called “false positive”. The financial payment authorization data processing system further includes a smart agent data structure to individually follow past transaction data and behaviors, and to provide its artificial intelligence observations on the level, type, and quality of payment card revenues and business routinely engaged in by the cardholder who's transaction request is on the table. The level of transaction risk that is acceptable is raised in proportion to the cardholder's business value. As a further device, such quality cardholders would never be subject to a “declined transaction” if the requested payment transaction was less than some generous minimum.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is functional block diagram a financial payment authorization data-processing system that includes a message data processor for accepting payment-authorization-transaction-request data messages over a typical secure network from a conventional financial network;

FIG. 2 is functional block diagram of a smart agent data structure of the present invention; and

FIG. 3 is a flowchart diagram illustrating the further data processing required in embodiments of the present invention when a transaction for a particular amount $X has already been preliminarily “declined” according to some other scoring model.

### DETAILED DESCRIPTION OF THE INVENTION

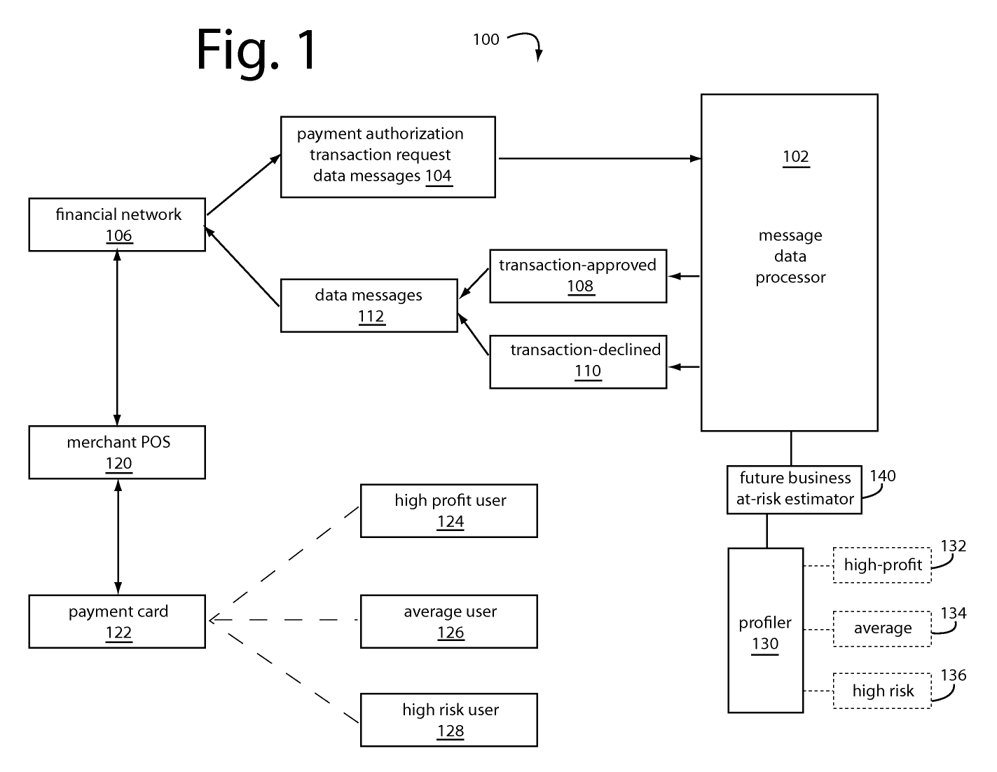

FIG. 1 represents a financial payment authorization data-processing system 100 that includes a message data processor 102 for accepting payment-authorization-transaction-request data messages 104 over a typical secure network from a conventional financial network 106. The message data processor 102 also responds in answer with transaction-approved decision 108 or transaction-declined decision 110 encoded in data messages 112. The financial network 106 includes millions of retail merchants of all types that accept payment cards for purchases, wherein a typical one is represented by a conventional merchant point-of-sale (POS) terminal 120.

Conventional payment cards 122 issued by banks and other commercial associations are distributed to at least three types of cardholders, high-profit users 124, average users 126, and high-risk users 128. The high-profit users 124 are those who generate a much higher than average volume of business, and therefore profits, to the banks and other commercial associations.

“Declining” a payment card transaction at any merchant POS terminal 120 has more of a consequence than the immediate consequences of losing the value of the instant transactions. People don't like being “declined”, it's embarrassing, and even a reason to become angry and look for retribution. That is especially true if the reason for declining the transaction is unjustified, silly, capricious, or obscure. Such consequences have traditionally been assumed as a cost of fraud control, technically, false positive indications of fraud when there in fact is no fraud afoot. At worst, these consequences have gone completely unaccounted for and unaddressed.

High profit users 124 have been observed to discontinue using the particular card and card brand that “embarrassed” them for an average of three months. The consequences to profits of losing three months of their business in particular is stunning.

A profiler 130 is used to track all payment card users having ever been responsible for generating a payment-authorization-transaction-request data messages 104. Each are followed and tracked using smart agents. Over time, these payment card users will fall into at least three categories of users: high-profit 132, average 134, and high risk 136. The updating of each payment card user as high-profit 132, average 134, and high risk 136, occurs in real-time and is generally good up to the minute.

In general, the processing of payment card transactions proceeds normally in financial payment authorization data-processing system 100. But, if message data processor 102 is about to respond with a transaction-declined decision 110, a future business at-risk estimator 140 is consulted. Profiler 130 looks in its profiles to see if the particular cardholder involved in the instant payment-authorization-transaction-request data message 104 has been previously categorized as high-profit 132.

If so, the transaction-declined decision 110 is suppressed or completely quashed. Instead, a transaction-approved decision 108 is sent. In one aspect, the transaction-declined decision 110 is suppressed is the computed risk score is unacceptably elevated. In another aspect of the present invention, the transaction-declined decision 110 is always quashed in the transaction dollar volume is below a predetermined threshold, e.g., 20% of average transaction dollar volumes in the last three months for the involved cardholder. Or, if empirical data supports it, any transaction involving a high-profit 132 categorized user will always be approved. The backstop on that is to cancel the payment card 122 when fraud has been proven for a fact later.

The message data processor 102 could be a standard networked data processing system widely used in card payment authorization systems around the world. But if so, they would have to specifically modified and adapted with both hardware and software to accept and work with the future-business at-risk estimator 140 and profiler 130.

The smart agents mentioned above are individual and compartmented data structures “assigned” to follow payment cards 122 as their presence manifests in millions of daily payment-authorization-transaction-request data messages 104. These can be securely maintained in profiler 130 or elsewhere. The present inventor, Dr. Akli Adjaoute, has described these smart agents in various forms in more than a dozen recent USPTO Patent Applications. These all are listed in the Table below and are fully incorporated by reference herein.

TABLE

| USPTO | | | |
|---|---|---|---|
| APPL. | OFFICIAL | | |
| NO | FILING DATE | TITLE | Published As |
| 14180370 | 14-FEB-2014 | Multi-Dimensional Behavior Device ID | US 2014-0164178 |
| | | http://www.google.com/patents/US20140164178 | Jun. 12, 2015 |
| 14243097 | 02-APR-2014 | Smart Analytics For Audience-Appropriate Commercial Messaging | n/a |
| 14454749 | 08-AUG-2014 | Healthcare Fraud Preemption | US 2015-0081324 |
| | | http://www.pat2pdf.org/patents/pat20150081324.pdf | Mar. 19, 2015 |
| 14514381 | 15-OCT-2014 | Artificial Intelligence Fraud Management Solution | US 2015-0032589 |
| | | http://www.google.com/patents/US20150032589 | Jan. 29, 2015 |
| 14517863 | 19-OCT-2014 | User Device Profiling In Transaction Authentications | US 2015-0039513 |
| | | http://www.google.com/patents/US20150039513 | Feb. 12, 2015 |
| 14525273 | 28-OCT-2014 | Data Breach Detection | US 2015-0073981 |
| | | http://www.google.com/patents/US20150073981 | Mar. 12, 2015 |
| 14521667 | 23-OCT-2014 | Behavior Tracking Smart Agents For Artificial Intelligence Fraud | US 2015-0046332 |
| | | Protection And Management | Feb. 12, 2015 |
| | | http://www.google.com/patents/US20150046332 | |
| 14521386 | 22-OCT-2014 | Reducing False Positives with Transaction Behavior Forecasting | US 2015-0046224 |
| | | http://www.google.com/patents/US20150046224 | Feb. 12, 2015 |
| 14520361 | 22-OCT-2014 | Fast Access Vectors In Real-Time Behavioral Profiling | US 2015-0066771 |
| | | http://www.google.com/patents/US20150066771 | Mar. 5, 2015 |
| 14517771 | 17-OCT-2014 | Real-Time Cross-Channel Fraud Protection | US 2015-0039512 |
| | | http://www.google.com/patents/US20150039512 | Feb. 5, 2015 |
| 14522463 | 23-OCT-2014 | Smart Retail Analytics And Commercial Messaging | US 2015-0046216 |
| | | http://www.google.com/patents/US20150046216 | Feb. 12, 2015 |
| 14634786 | 28-FEB-2015 | System Administrator Behavior Analysis | n/a |
| 14517872 | 19-OCT-2014 | Healthcare Fraud Protection And Management | US 2015-0046181 |
| | | http://www.google.com/patents/US20150046181 | Feb. 12, 2015 |
| 14675453 | 31-MAR-2015 | Behavioral Device Identifications Of User Devices Visiting | |
| | | Websites | |
| 14613383 | 04-FEB-2015 | Artificial Intelligence For Context Classifier | n/a |
| 14673895 | 31-MAR-2015 | Addressable Smart Agents | |

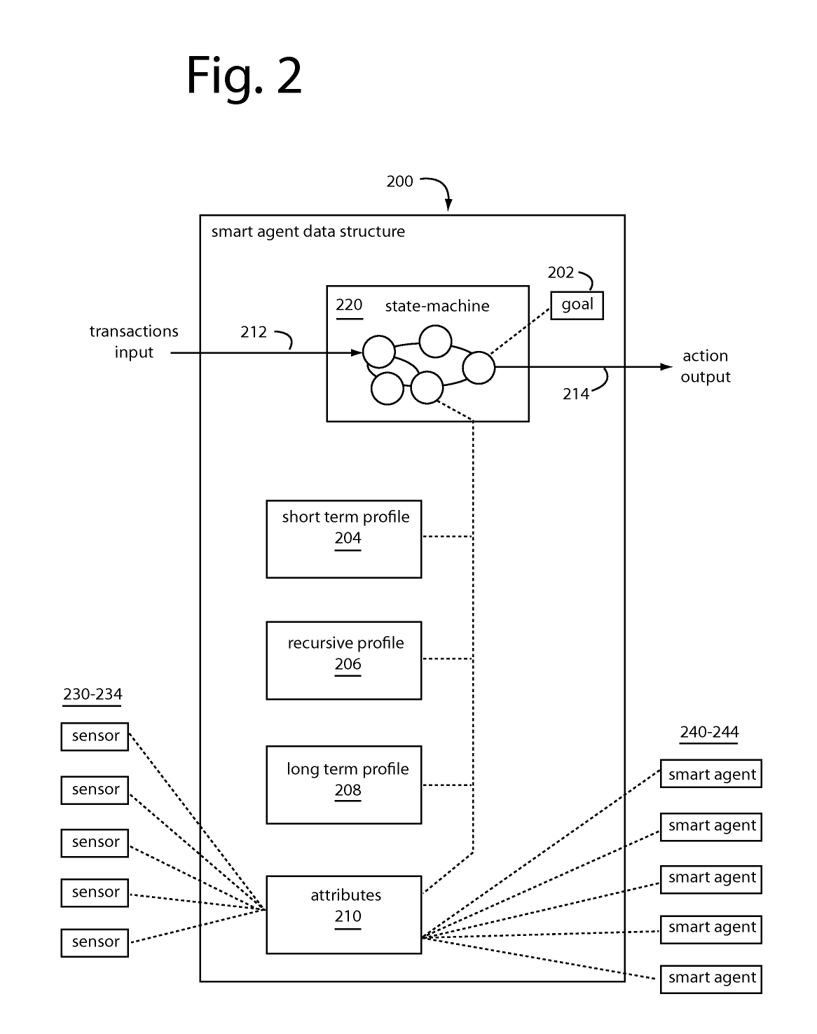

In FIG. 2, numerous smart agent data structures, represented herein by a single smart agent data structure 200, each include a “goal” encoding 202, a short term profile 204, a recursive profile 206, a long term profile 208, and attributes 210 that describe the particular entity 210 that this single smart agent data structure 200 has been assigned to track.

Smart agent data structure 200 will receive distillations of millions of daily payment-authorization-transaction-request data messages 212 that have been cleaned of extraneous data and inconsistencies, enriched by extrapolations and interpolations, and tupled for fast access and interpretation of the payment cards 122 they are “assigned” to follow. (A “tuple” is a data structure that has a specific number and sequence of elements.) These data are moved into corresponding short term profiles 204, recursive profiles 206, and long term profiles 208 by a state machine 220. The state-machine 220 will occasionally or responsively produce an action output 214.

Attributes 210 can be fixed, variable, or programmable. In the case of a payment cardholder entity, a fixed attribute would be a social security number, a biometric, etc. A variable attribute could be slow-changing like a billing address, or fast-changing like a shopping location. Variable attributes could be data obtained from sensors 230-234, like GPS receivers, temperature sensors, light sensors, sound sensors, etc. Programmable attributes can include account numbers, PIN numbers, passwords, expiry dates, etc.

“Unfamiliar” attributes are datapoint tupled from incoming transaction records that are unique to a recent series of transactions. They may also be inconsistent or impossible, like a $512 charge for gasoline. Or a purchase in Europe at near the same time as one in South Dakota, especially if the cardholder has a billing address in Mill Valley, Calif.

Attributes too are usefully assigned their own smart agents 240-244 that link back to attributes 210. For example, an attribute smart agent for billing addresses, can have as its attributes all the addresses of all the cardholder entities with an assigned smart agent data structure 200. It could be quickly determined, if necessary, which cardholders share billing addresses or have ones near others.

State-machine 220 begins its steps through its internal sequences step-by-step as transaction input data 212 is received for it. These sequences routinely squirrel-away the data components in the appropriate tuples maintained in short term profiles 204, recursive profiles 206, and long term profiles 208. The action output 214 required by the inputting can be implied to be a score of the behavior for this entity in this transaction as being normal, given their past behaviors manifested in past transaction data. Or it could be a command to decline the transaction, or cancel the payment card altogether.

Goal encoding 202 is a machine-readable way for the state-machine 220 to template the action output 214 about to be produced against a goal or objective like fraud reduction, profit maximization, false positives control, goodwill, etc. It may be necessary for state-machine 220 to have correlation tables that plot goals 202 versus action outputs 214 in order to decide whether or not to issue the looming action output 214. Case based reasoning too can be employed to judge what decisions under which circumstances (attributes) resulted in favorable outcomes.

In a completely different application of smart agent data structures 200, a request by a systems administrator to dump all sensitive cardholder data a personally identifiable information to a single USB thumb drive at 1:30 AM on a Sunday morning could be compared to a goal 202 of data security and denied as an action output 214.

Payment transaction request fraud scoring data structures are, in operation, subject to occasionally falsely scoring a legitimate transaction related to a cardholder by a payment authorization request data message as fraudulent, and that would otherwise be able to deliver a transaction-declined data message in the answer.

In general, embodiments of the present invention rely on a data memory for individually profiling past transaction data and behaviors 122 corresponding cardholders. These are derived from a series of past payment authorization request data messages. An artificial intelligence machine compute and reports its observations on the magnitude, type, and quality of payment card revenues and business routinely engaged in by each cardholder involved in a particular incoming payment authorization transaction request data message. Such includes a means for computing and adjusting an instant acceptable level of transaction risk that is proportioned to a computed value of a corresponding cardholder's past business. Also needed is a mechanism for answering a particular instant payment authorization transaction request data message with a transaction-approved data message that depends on an adjustment of the instant acceptable level of transaction risk.

In certain instances, it would be appropriate to always deliver a transaction-approved data messages in answer to a payment authorization transaction request data message if the underlying transaction amount is less than a predetermined minimum amount. The instant predetermined minimum amount can be proportioned to the computed value of the corresponding cardholder's past business.

Each “channel” of payment mechanism used in electronic financial transactions has its own idiosyncrasies and peculiarities that can mask or obscure fraud. What is also true is most of us are able to “pay” for our purchases in several different ways, each using different channels. For example, checks, credit cards, ACH, debit cards, company cards, and gift cards all represent different channels that can be abused by fraudsters.

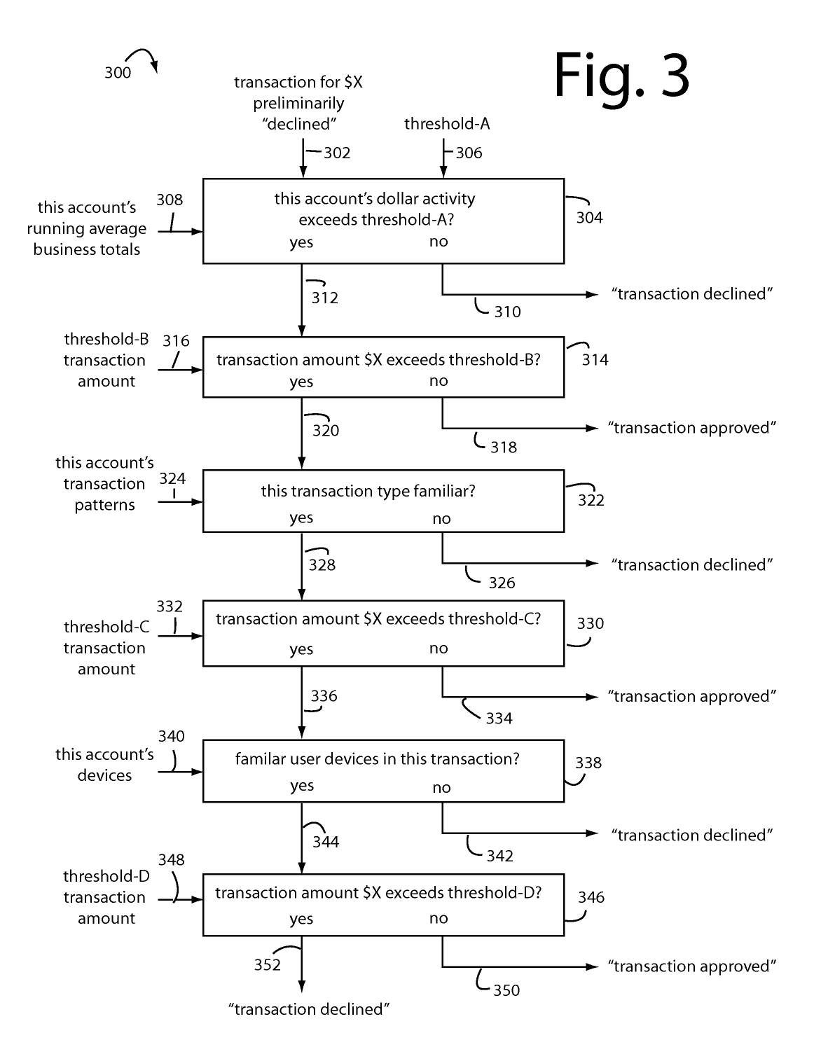

FIG. 3 represents a data structure 300 for the further data processing required in embodiments of the present invention when a payment card transaction for a particular transaction amount $X has already been preliminarily “declined” and included in a decision 302 according to some other scoring model. A test 304 compares a dollar transaction “threshold amount-A” 306 to a computation 308 of the running average business this particular user has been doing with this account involved. The thinking here is that valuable customers who do more than an average amount (threshold-A 306) of business with their payment card should not be so easily or trivially declined. Some artificial intelligence deliberation is appropriate.

If, however test 304 decides that the accountholder has not earned special processing, a “transaction declined” decision 310 is issued as final (transaction-declined 110). Such is then forwarded by the financial network 106 to the merchant POS 120.

But when test 304 decides that the accountholder has earned special processing, a transaction-preliminarily-approved decision 312 is carried forward to a test 314. A threshold-B transaction amount 316 is compared to the transaction amount $X. Essentially, threshold-B transaction amount 316 is set at a level that would relieve qualified accountholders of ever being denied a petty transaction, e.g., under $250, and yet not involve a great amount of risk should the “positive” scoring indication from the “other scoring model” not prove much later to be “false”. If the transaction amount $X is less than threshold-B transaction amount 316, a “transaction approved” decision 318 is issued as final (transaction-approved 108). Such is then forwarded by the financial network 106 to the merchant POS 120.

If the transaction amount $X is more than threshold-B transaction amount 316, a transaction-preliminarily-approved decision 320 is carried forward to a familiar transaction pattern test 322. An abstract 324 of this account's transaction patterns is compared to the instant transaction. For example, if this accountholder seems to be a new parent with a new baby as evidenced in purchases of particular items, then all future purchases that could be associated are reasonably predictable. Or, in another example, if the accountholder seems to be on business in a foreign country as evidenced in purchases of particular items and travel arrangements, then all future purchases that could be reasonably associated are to be expected and scored as lower risk. And, in one more example, if the accountholder seems to be a professional gambler as evidenced in cash advances at casinos, purchases of specific things and arrangements, then these future purchases too could be reasonably associated are be expected and scored as lower risk.

So if the transaction type is not a familiar one, then a “transaction declined” decision 326 is issued as final (transaction-declined 110). Such is then forwarded by the financial network 106 to the merchant POS 120. Otherwise, a transaction-preliminarily-approved decision 328 is carried forward to a threshold-C test 330.

A threshold-C transaction amount 332 is compared to the transaction amount $X. Essentially, threshold-C transaction amount 332 is set at a level that would relieve qualified accountholders of being denied a moderate transaction, e.g., under $2500, and yet not involve a great amount of risk because the accountholder's transactional behavior is within their individual norms. If the transaction amount $X is less than threshold-C transaction amount 332, a “transaction approved” decision 334 is issued as final (transaction-approved 108). Such is then forwarded by the financial network 106 to the merchant POS 120.

If the transaction amount $X is more than threshold-C transaction amount 332, a transaction-preliminarily-approved decision 336 is carried forward to a familiar user device recognition test 338. An abstract 340 of this account's user devices is compared to those used in the instant transaction.

So if the user device is not recognizable as one employed by the accountholder, then a “transaction declined” decision 342 is issued as final (transaction-declined 110). Such is then forwarded by the financial network 106 to the merchant POS 120. Otherwise, a transaction-preliminarily-approved decision 344 is carried forward to a threshold-D test 346.

A threshold-D transaction amount 348 is compared to the transaction amount $X. Basically, the threshold-D transaction amount 348 is set at a higher level that would avoid denying substantial transactions to qualified accountholders, e.g., under $10,000, and yet not involve a great amount of risk because the accountholder's user devices are recognized and their instant transactional behavior is within their individual norms. If the transaction amount $X is less than threshold-D transaction amount 332, a “transaction approved” decision 350 is issued as final (transaction-approved 108). Such is then forwarded by the financial network 106 to the merchant POS 120.

Otherwise, the transaction amount $X is just too large to override a denial if the other scoring model decision 302 was “positive”, e.g., for fraud, or some other reason. In such case, a “transaction declined” decision 352 is issued as final (transaction-declined 110). Such is then forwarded by the financial network 106 to the merchant POS 120.

In general, threshold-B 316 is less than threshold-C 332, which in turn is less than threshold-D 348. It could be that tests 322 and 338 would serve profits better if swapped in FIG. 3. Embodiments of the present invention would therefore include this variation as well. It would seen that threshold-A 306 should be empirically derived and driven by business goals.

The further data processing required by data structure 300 occurs in real-time while merchant POS 120 and users 124, 126, and 128 wait for approved/declined data messages 112 to arrive through financial network 106. The consequence of this is that the abstracts for this-account's-running-average-totals 308, this account's-transaction-patterns 324, and this-account's-devices 340 must all be accessible and on-hand very quickly. A simple look-up is preferred to having to compute the values. The smart agents and the behavioral profiles they maintain and that we've described in this Application and those we incorporate herein by reference are up to doing this job well. Conventional methods and apparatus may struggle to provide these information. Our USPTO Patent Application 14675453, filed, 31 Mar. 2015, and titled, Behavioral Device Identifications Of User Devices Visiting Websites, describes a few ways to gather and have on-hand abstracts for this-account's-devices 340.

The present inventor, Dr. Akli Adjaoute and his Company, Brighterion, Inc. (San Francisco, Calif.), have been highly successful in developing fraud detection computer models and applications for banks, payment processors, and other financial institutions. In particular, these fraud detection computer models and applications are trained to follow and develop an understanding of the normal transaction behavior of single individual accountholders. Such training is sourced from multi-channel transaction training data or single-channel. Once trained, the fraud detection computer models and applications are highly effective when used in real-time transaction fraud detection that comes from the same channels used in training.

Some embodiments of the present invention train several single-channel fraud detection computer models and applications with corresponding different channel training data. The resulting, differently trained fraud detection computer models and applications are run several in parallel so each can view a mix of incoming real-time transaction message reports flowing in from broad diverse sources from their unique perspectives. One may compute a “hit” the others will miss, and that's the point.

If one differently trained fraud detection computer model and application produces a hit, it is considered herein a warning that the accountholder has been compromised or has gone rogue. The other differently trained fraud detection computer models and applications should be and are sensitized to expect fraudulent activity from this accountholder in the other payment transaction channels. Hits across all channels are added up and too many can be reason to shut down all payment channels for the affected accountholder.

In general, a process for cross-channel financial fraud protection comprises training a variety of real-time, risk-scoring fraud model data structures with training data selected for each from a common transaction history to specialize each member in the monitoring of a selected channel. Then arranging the variety of real-time, risk-scoring fraud model data structures after the training into a parallel arrangement so that all receive a mixed channel flow of real-time transaction data or authorization requests. The parallel arrangement of diversity trained real-time, risk-scoring fraud model data structures is hosted on a network server platform for real-time risk scoring of the mixed channel flow of real-time transaction data or authorization requests. Risk thresholds are immediately updated for particular accountholders in every member of the parallel arrangement of diversity trained real-time, risk-scoring fraud model data structures when any one of them detects a suspicious or outright fraudulent transaction data or authorization request for the accountholder. So, a compromise, takeover, or suspicious activity of the accountholder's account in any one channel is thereafter prevented from being employed to perpetrate a fraud in any of the other channels.

Such process for cross-channel financial fraud protection can further comprise steps for building a population of real-time and a long-term and a recursive profile for each the accountholder in each the real-time, risk-scoring fraud model data structures. Then during real-time use, maintaining and updating the real-time, long-term, and recursive profiles for each accountholder in each and all of the real-time, risk-scoring fraud model data structures with newly arriving data. If during real-time use a compromise, takeover, or suspicious activity of the accountholder's account in any one channel is detected, then updating the real-time, long-term, and recursive profiles for each accountholder in each and all of the other real-time, risk-scoring fraud model data structures to further include an elevated risk flag. The elevated risk flags are included in a final risk score calculation 728 for the current transaction or authorization request.

Fifteen-minute vectors are a way to cross pollinate risks calculated in one channel with the others. The 15-minute vectors can represent an amalgamation of transactions in all channels, or channel-by channel. Once a 15-minute vector has aged, it can be shifted into a 30-minute vector, a one-hour vector, and a whole day vector by a simple shift register means. These vectors represent velocity counts that can be very effective in catching fraud as it is occurring in real time.

In every case, embodiments of the present invention include adaptive learning that combines three learning techniques to evolve the artificial intelligence classifiers. First is the automatic creation of profiles, or smart-agents, from historical data, e.g., long-term profiling. The second is real-time learning, e.g., enrichment of the smart-agents based on real-time activities. The third is adaptive learning carried by incremental learning algorithms.

For example, two years of historical credit card transactions data needed over twenty seven terabytes of database storage. A smart-agent is created for each individual card in that data in a first learning step, e.g., long-term profiling. Each profile is created from the card's activities and transactions that took place over the two year period. Each profile for each smart-agent comprises knowledge extracted field-by-field, such as merchant category code (MCC), time, amount for an mcc over a period of time, recursive profiling, zip codes, type of merchant, monthly aggregation, activity during the week, weekend, holidays, Card not present (CNP) versus card present (CP), domestic versus cross-border, etc. this profile will highlights all the normal activities of the smart-agent (specific payment card).

Smart-agent technology has been observed to outperform conventional artificial and machine learning technologies. For example, data mining technology creates a decision tree from historical data. When historical data is applied to data mining algorithms, the result is a decision tree. Decision tree logic can be used to detect fraud in credit card transactions. But, there are limits to data mining technology. The first is data mining can only learn from historical data and it generates decision tree logic that applies to all the cardholders as a group. The same logic is applied to all cardholders even though each merchant may have a unique activity pattern and each cardholder may have a unique spending pattern.

A second limitation is decision trees become immediately outdated. Fraud schemes continue to evolve, but the decision tree was fixed with examples that do not contain new fraud schemes. So stagnant non-adapting decision trees will fail to detect new types of fraud, and do not have the ability to respond to the highly volatile nature of fraud.

Another technology widely used is “business rules” which requires actual business experts to write the rules, e.g., if-then-else logic. The most important limitations here are that the business rules require writing rules that are supposed to work for whole categories of customers. This requires the population to be sliced into many categories (students, seniors, zip codes, etc.) and asks the experts to provide rules that apply to all the cardholders of a category.

How could the US population be sliced? Even worse, why would all the cardholders in a category all have the same behavior? It is plain that business rules logic has built-in limits, and poor detection rates with high false positives. What should also be obvious is the rules are outdated as soon as they are written because conventionally they don't adapt at all to new fraud schemes or data shifts.

Neural network technology also limits, it uses historical data to create a matrix weights for future data classification. The Neural network will use as input (first layer) the historical transactions and the classification for fraud or not as an output). Neural Networks only learn from past transactions and cannot detect any new fraud schemes (that arise daily) if the neural network was not re-trained with this type of fraud. Same as data mining and business rules the classification logic learned from the historical data will be applied to all the cardholders even though each merchant has a unique activity pattern and each cardholder has a unique spending pattern.

Another limit is the classification logic learned from historical data is outdated the same day of its use because the fraud schemes changes but since the neural network did not learn with examples that contain this new type of fraud schemes, it will fail to detect this new type of fraud it lacks the ability to adapt to new fraud schemes and do not have the ability to respond to the highly volatile nature of fraud.

Contrary to previous technologies, smart-agent technology learns the specific behaviors of each cardholder and create a smart-agent that follow the behavior of each cardholder. Because it learns from each activity of a cardholder, the smart-agent updates the profiles and makes effective changes at runtime. It is the only technology with an ability to identify and stop, in real-time, previously unknown fraud schemes. It has the highest detection rate and lowest false positives because it separately follows and learns the behaviors of each cardholder.

Smart-agents have a further advantage in data size reduction. Once, say twenty-seven terabytes of historical data is transformed into smart-agents, only 200-gigabytes is needed to represent twenty-seven million distinct smart-agents corresponding to all the distinct cardholders.

Incremental learning technologies are embedded in the machine algorithms and smart-agent technology to continually re-train from any false positives and negatives that occur along the way. Each corrects itself to avoid repeating the same classification errors. Data mining logic incrementally changes the decision trees by creating a new link or updating the existing links and weights. Neural networks update the weight matrix, and case based reasoning logic updates generic cases or creates new ones. Smart-agents update their profiles by adjusting the normal/abnormal thresholds, or by creating exceptions.

Although particular embodiments of the present invention have been described and illustrated, such is not intended to limit the invention. Modifications and changes will no doubt become apparent to those skilled in the art, and it is intended that the invention only be limited by the scope of the appended claims.

The invention claimed is:

1. A financial payment authorization data processing system comprises:
means for data processing of payment authorization transaction request data messages from a financial network, and for responding with transaction-approved or transaction-declined data messages in answer;
a payment transaction request fraud scoring data structure that is in operation subject to occasionally falsely scoring a legitimate transaction related to a cardholder by a payment authorization request data message as fraudulent, and that would otherwise be able to deliver a transaction-declined data message in said answer;
a smart agent data structure including data memory for individually profiling past transaction data and behaviors for cardholders as derived from said payment authorization request data messages, and enabled by artificial intelligence to compute and report its observations on the magnitude, type, and quality of payment card revenues and business routinely engaged in by each cardholder involved in a particular incoming payment authorization transaction request data message;
means for computing and adjusting an instant acceptable level of transaction risk that is proportioned to a computed value of a corresponding cardholder's past business; and
means for answering a particular instant payment authorization transaction request data message with a transaction-approved data message that depends on an adjustment of said instant acceptable level of transaction risk.

2. The financial payment authorization data processing system of claim 1, further comprising:
means for always delivering a transaction-approved data messages in answer to a payment authorization transaction request data message if the underlying transaction amount is less than a predetermined minimum amount.

3. The financial payment authorization data processing system of claim 2, further comprising:
means for computing and adjusting said instant predetermined minimum amount that is proportioned to said computed value of said corresponding cardholder's past business.

4. A computer network automated method for increasing the operating profits of payment card issuers through artificial machine intelligence manipulation of payment transaction request authorization financial networks to response with additional transaction-approved messages when particular favored high profit cardholder accounts are involved in an instant transaction, comprising:
a step for collecting and tracking transaction reports according to particular cardholder accounts manifest in each such report;
a step for categorizing some of the particular cardholder accounts as being high-profit according to recent dollar volumes of business generated that have been extracted from earlier transaction reports and compartmentally stored in profiles; and
a step for changing a transaction-declined message about to issue from a payment transaction request authorization financial network to a transaction-approved message if a instant transaction is detected to involve a particular cardholder account categorized as being high-profit.

5. The method of claim 4, further comprising:
a step for not changing said transaction-declined message to said transaction-approved message if said instant transaction involves more than a predetermined dollar amount.

6. The method of claim 4, further comprising:
a step for not changing said transaction-declined message to said transaction-approved message if said instant transaction includes unfamiliar attributes or transaction record datapoints with respect to the particular cardholder account categorized as being high-profit.

7. The method of claim 4, further comprising:
a step for changing said transaction-declined message to a transaction-approved message if said instant transaction is detected to be local to a billing address associated with the particular cardholder account categorized as being high-profit.

8. A data structure included in a data processing system for further processing of a computed decision from a scoring model to decline a financial system payment transaction, comprising:
means for abstracting the revenue or profit values of past business transactions generated solely by an individual payment card;
means for abstracting particular purchasing patterns evident in said past business transactions;
means for abstracting configurational characteristics of any user devices employed in said past business transactions;
means for making a first comparison of an abstract of revenue or profit values of past business transactions generated solely by an individual payment card to that manifesting in an instant business transaction;
means for making a second comparison of an abstract of the particular purchasing patterns evident in said past business transactions to that manifesting in an instant business transaction;
means for making a third comparison of an abstract of the configurational characteristics of said user devices employed in said past business transactions to that manifesting in an instant business transaction;
means for overriding a preliminary transaction-declined decision computed by a financial system payment transaction scoring model to decline said instant business transaction, wherein such overriding depends on a result obtained in any of said second first, second, or third comparisons; and
means for communicating instead a transaction-approved message through a financial system.

9. The data structure of claim 8, further comprising:
means for overriding said preliminary transaction-declined decision further depends on said instant business transaction not exceeding a threshold value.

10. The data structure of claim 8, further comprising:
means for overriding said preliminary transaction-declined decision further depends on said instant business transaction not exceeding a first threshold value if said first comparison was positive.

11. The data structure of claim 8, further comprising:
means for overriding said preliminary transaction-declined decision further depends on said instant business transaction not exceeding a second threshold value if said second comparison was positive.

12. The data structure of claim 8, further comprising:
means for overriding said preliminary transaction-declined decision further depends on said instant business transaction not exceeding a third threshold value if said third comparison was positive.
